(19) United States
(12) Patent Application Publication
(10) Pub. No.: US 2015/0300309 A1
(43) Pub. Date: Oct. 22, 2015

(54) ELECTRIC STARTING DEVICE FOR A GASOLINE ENGINE

(71) Applicant: GOLDEN LION ENTERPRISE CO., LTD., Taichung City (TW)

(72) Inventor: Lien-Sheng CHANG, Taichung City (TW)

(73) Assignee: GOLDEN LION ENTERPRISE CO., LTD., Taichung City (TW)

(21) Appl. No.: 14/257,648

(22) Filed: Apr. 21, 2014

(51) Int. Cl. F02N 15/02

(52) U.S. Cl. CPC F02N 15/021

(57) ABSTRACT

An electric starting device for a gasoline engine includes a clutch, an adapter and a motor. The clutch further provided with a flail block seat and a flail block seat. The flail block seat is pivotally disposed with flail blocks able to be optionally engaged in the starting claw, while the starting claw is combined with the motor via the adapter and the flail block seat is to be combined with the crankshaft of an engine. Thus, the motor can be started to drive the crankshaft to rotate through the clutch for starting the engine and when the engine is started to operate, the centrifugal force produced by rotation of the crankshaft will force the flail blocks to disengage from the starting claw and hence, the starting claw, the adapter and the motor will be disconnected from the crankshaft, able to effectively lower load of the engine and reduce power consumption.

### BACKGROUND OF THE INVENTION

1. Field of the Invention

This invention relates to an engine starting device, particularly to an electric starting device for a gasoline engine.

2. Description of the Prior Art

A conventional gasoline engine, such as a model gasoline engine, generally has to be started by a starting apparatus and then begins to operate by itself to carry out circulation of whole travel. A hand starting apparatus of a conventional gasoline engine, as shown in FIGS. 1-3, is assembled with a crankshaft 200 of an engine, and the hand starting apparatus is a kick starter containing a kicking capstan 1 that is coaxial with the crankshaft 200. The kicking capstan 1 is provided with a clutch 2 to enable the kicking capstan 1 to be combined with the crankshaft 200 via the clutch 2, and further provided with a kicking rope 3 that is wound around the circumference of the kicking capstan 1. When the kicking rope 3 is pulled by hands, the kick starter will actuate the kicking capstan 1 to run around and drive the crankshaft 200 to rotate via the clutch 2 and thus, the conventional gasoline engine can be started to operate. After the engine is started, the centrifugal force produced when the crankshaft 200 drives the clutch 2 to rotate will make the kicking capstan 1 release and disengage from the crankshaft 200 through the clutch 2 and thus, in an operation process of the engine, the kicking capstan 1 is needless to be rotated again.

The hand staring apparatus of the conventional gasoline engine must be pulled by hands to start the engine, and pulling the kicking rope 3 for starting the engine has to be done very fast and the rope 3 has to be pulled out to a great extent; therefore, weak children or women can hardly drive the engine to operate, resulting in trouble in operation. Further, to start the conventional gasoline engine in an environment of lower temperature, due to cold engine, it is necessary to pull the kicking rope 3 repeatedly for several times to drive the kicking capstan 1 to rotate for staring the gasoline engine, also causing trouble in operation. In view of the defects mentioned above, the inventor of this invention thinks that the hand starting apparatus of the conventional gasoline engine has to be ameliorated and hence devise this invention.

### SUMMARY OF THE INVENTION

The objective of this invention is to offer an electric starting device for a gasoline engine, able to start an engine easily, facilitating to be operated, and easy to disengage from an engine for effectively lower load of the engine and reduce power consumption in a rotation process of the engine.

The electric starting device for a gasoline engine in the present invention includes a clutch consisting of a stating claw and a flail block seat. The starting claw has its circumferential edge radially disposed with at least one engage recess, and the flail block seat is pivotally assembled thereon with a flail block corresponding with the engage recess of the starting claw so that the flail block can optionally be engaged in the engage recess. The starting claw is further engaged with an adapter that is combined with the rotating shaft of a motor.

The flail block seat of the electric starting device for a gasoline engine of this invention can be mounted with the crankshaft of a gasoline engine, and before the gasoline engine is started, the flail block of the flail block seat is positioned in the engage recess. To start the gasoline engine, the motor is started to actuate the clutch to turn around and drive the crankshaft to rotate for starting the gasoline engine. When the gasoline engine begins to operate, the centrifugal force produced by rotating of the crankshaft will force the flail block to disengage from the engage recess and thus, the starting claw, the adapter and the motor will be disconnected from the crankshaft. By so designing, a user can easily start the gasoline engine by making use of the motor, and in a rotation process of the gasoline engine, the gasoline engine is needless to drive the starting claw, the adapter and the motor to work, able to lower load of the engine and decrease power consumption.

### BRIEF DESCRIPTION OF DRAWINGS

This invention will be better understood by referring to the accompanying drawings, wherein:

FIG. 1 is a schematic view of a hand starting apparatus to be assembled with a conventional gasoline engine;

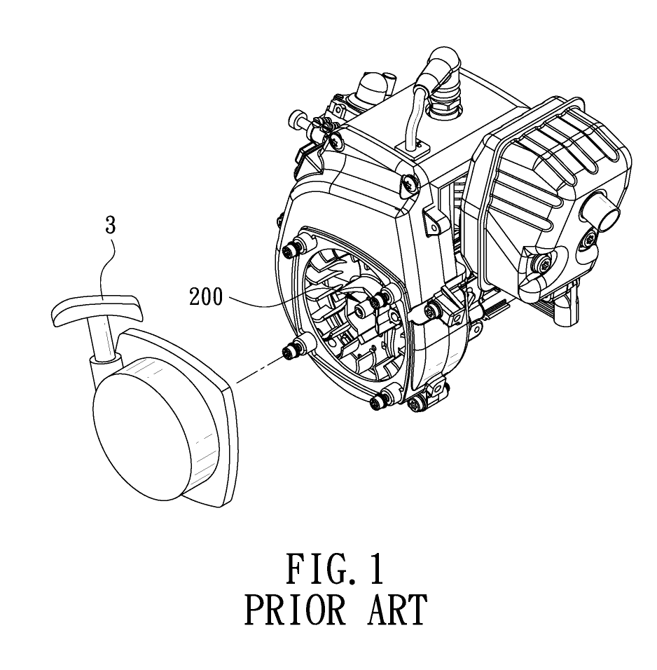

FIG. 2 is a perspective view of the hand starting apparatus of the conventional gasoline engine;

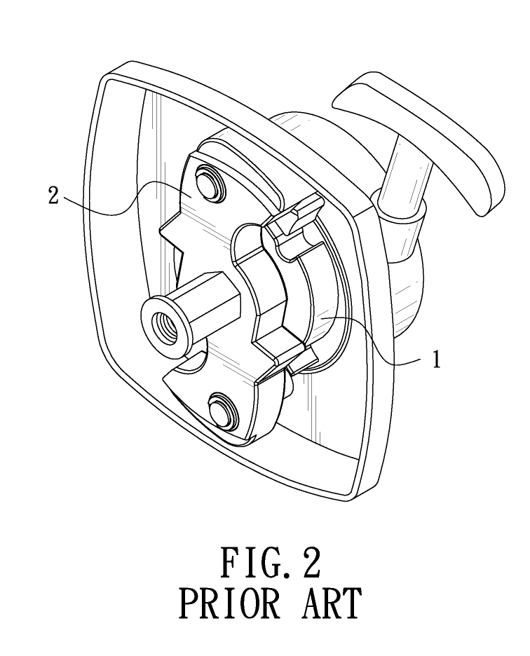

FIG. 3 is an exploded perspective view of the hand starting apparatus of the conventional gasoline engine;

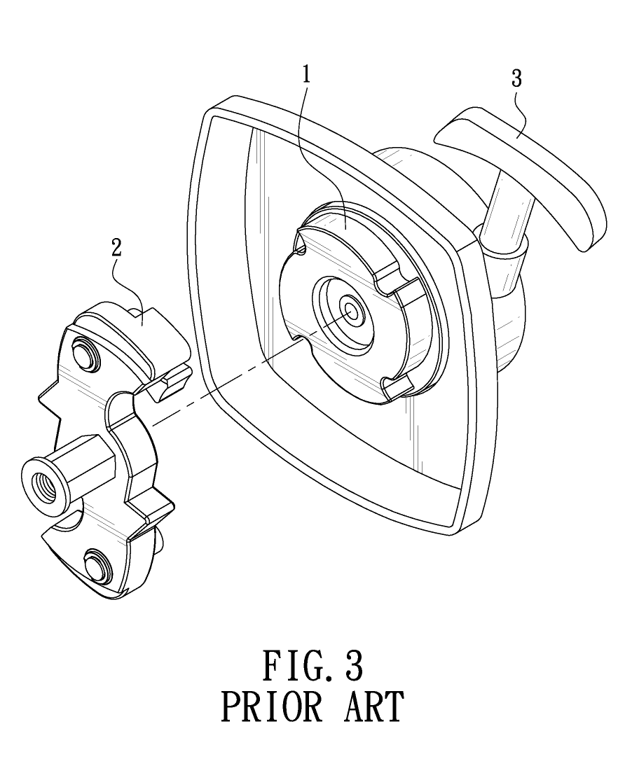

FIG. 4 is a perspective view of an electric starting device for a gasoline engine in the present invention;

FIG. 5 is an exploded perspective view of the electric starting device for a gasoline engine in the present invention;

FIG. 6 is an exploded perspective view of the electric starting device viewed at another visual angle in the present invention;

FIG. 7 is a schematic view of the electric starting device to be assembled with a gasoline engine in the present invention;

FIG. 8 is a schematic view of the electric starting device combined with a gasoline engine for use in the present invention, showing a state before the engine is started; and

FIG. 9 is a schematic view of the electric starting device combined with a gasoline engine for use in the present invention, showing a state after the engine is started.

### DETAILED DESCRIPTION OF THE PREFERRED EMBODIMENT

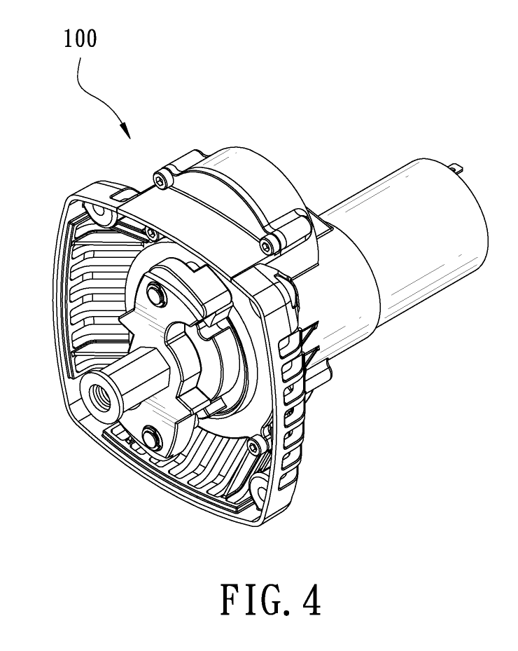

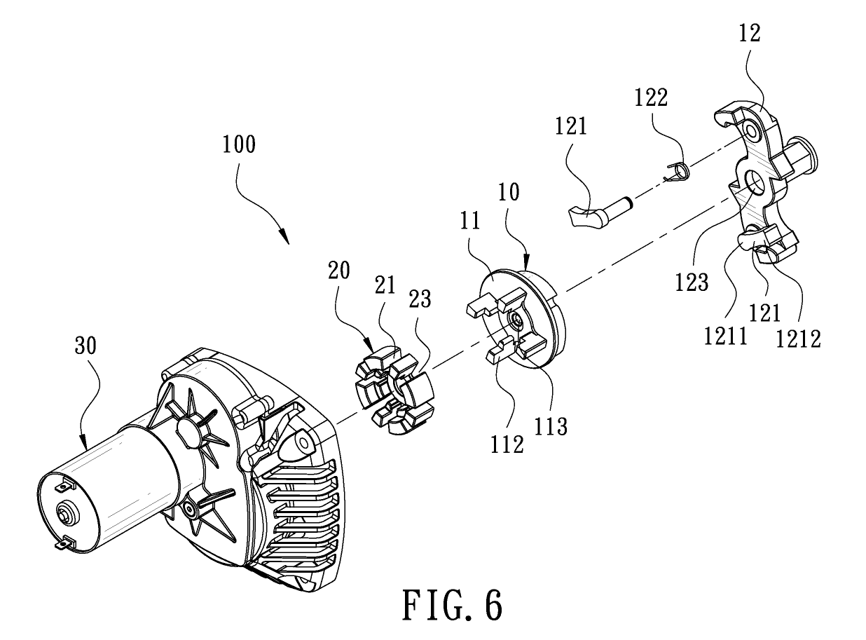

A preferred embodiment of an electric starting device 100 for a gasoline engine in the present invention, as shown in FIGS. 4-6, is to be combined with the crankshaft 200 of an engine and includes a clutch 10, an adapter 20 and a motor 30 as main components combined together.

The clutch 10 is coaxial with the crankshafts 200 of the engine, consisting of a starting claw 11 and a flail block seat 12. The starting claw 11 is disk-shaped and has its circumferential edge radially provided with at least one engage recess 111. In this invention, the starting claw 11 is provided with four engage recesses 111 spaced apart equi-angularly, and the circumferential wall of one side of the engage recess 111 is perpendicular to the circumferential edge of the starting claw 11, while the circumferential wall of another side of the engage recess 111 gradually increases the depth of the engage recess 111 along the circumferential edge of the starting claw 11, and the four engage recesses 111 gradually increase their depth along the same direction. Further, the starting claw 11 has one side axially disposed with a plurality of combination ribs 112 and a central portion axially bored with a second through hole 113. The flail block seat 12 is axially juxtaposed with the starting claw 11 along the crankshaft 200 and positioned at one side of the starting claw 11, that is, at the opposite side of the combination ribs 112, and has one side, which faces the starting claw 11, axially and pivotally mounted with at least one flail block 121 at a location corresponding to the engage recess 111 so that the flail block 121 can optionally be engaged in the engage recess 111. In the present invention, two flail blocks 121 are respectively disposed at the two opposite ends of the flail block seat 12, and each flail block 121 has one end pivotally fixed with the flail block seat 12 to form a pivotal end 1211 and another end is a free end 1212. The pivotal end 1211 of the flail block 121 is corresponding to the circumferential wall of one side of the engage recess 111, where the depth of the engage recess 111 is gradually increased, while the free end of the flail block 121 is corresponding to the circumferential wall of another side of the engage recess 111, which is perpendicular to the circumferential edge of the starting claw 11. The flail block seat 12 is further provided with a restoring member 122 at the pivotal location of the flail block 121 so that the free end 1212 of the flail block 121 can be engaged in the engage recess 111 by restoring force of the restoring member 122. In this invention, the restoring member 122 is a return spring. Furthermore, the flail block seat 12 has its center axially bored with a first through hole 123 corresponding with the second through hole 113 of the starting claw 11.

The adapter 20 is axially juxtaposed with the clutch 10 along the crankshaft 200, letting the clutch 10 engaged and combined with the adapter 20. The adapter 20 of this invention is formed with a plurality of combination grooves 21 respectively corresponding with the combination ribs 112 of the starting claw 11 and axially piercing through the adapter 20 and also radially stretching to the circumferential edge of the adapter 20. Thus, the clutch 10 can be engaged and combined with the combination grooves 21 of the adapter 20 by means of the combination ribs 112 of the starting claw 11. The adapter 20 has its center bored with a third through hole 22 corresponding with the second through hole 113 of the starting claw 11 and is radially disposed with a plurality of engage grooves 23 respectively separated by the combination groove 21, with the engage grooves 23 axially piercing through the adapter 20 and radially extending to the circumferential edge of the adapter 20.

The motor 30 is provided with a rotating shaft 31 that is radially disposed with a plurality of ribs 32 respectively corresponding with the engage grooves 23 of the adapter 20 so that the engage grooves 23 of the adapter 20 can be engaged with the ribs 32 of the rotating shaft 31 and hence, the motor 30 can drive the adapter 20 to rotate synchronously via the rotating shaft 31.

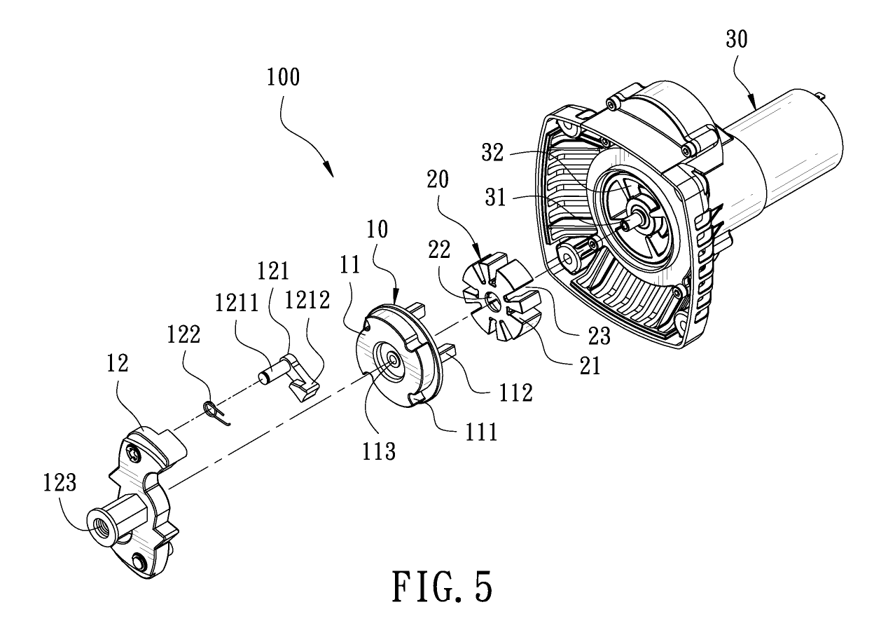

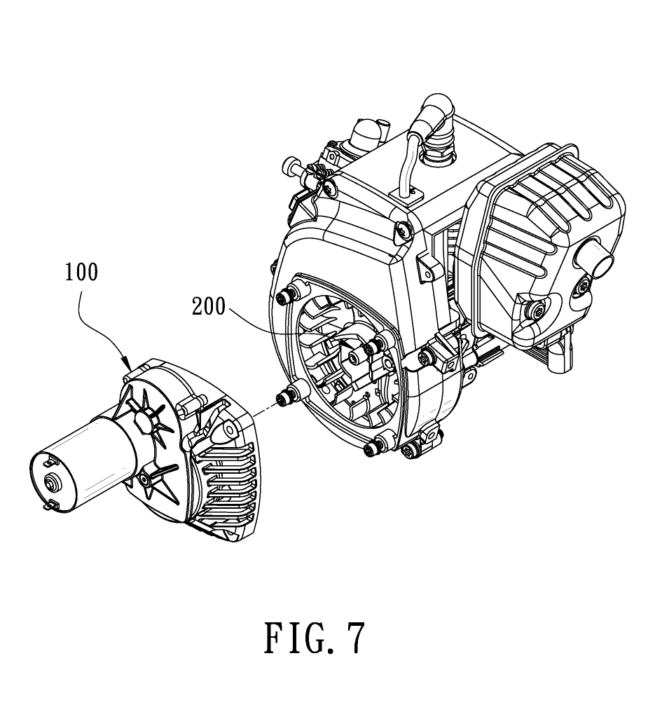

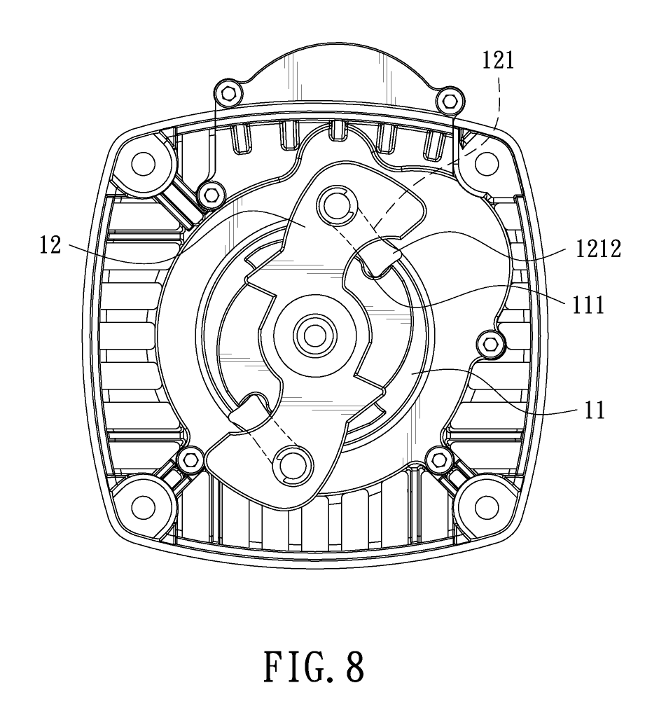

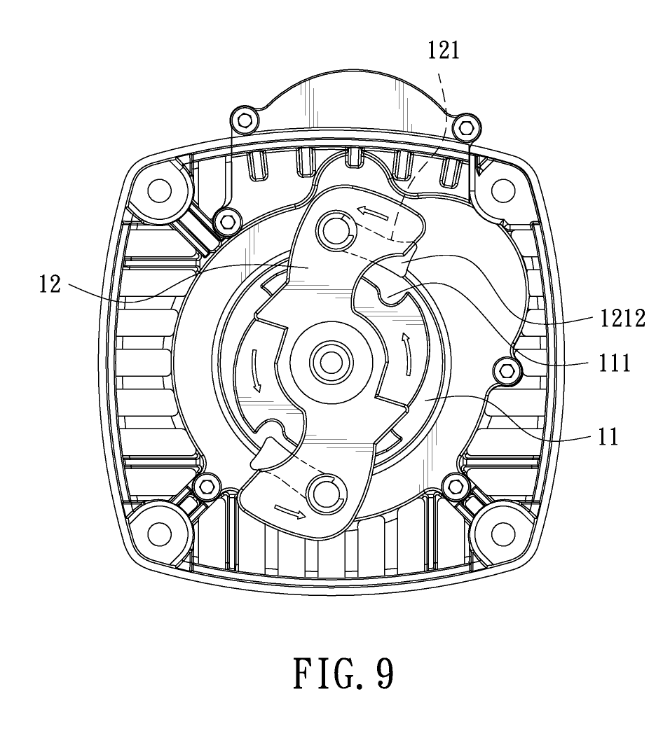

In use, referring to FIGS. 8 and 9 and FIGS. 5-7, the electric starting device 100 of this invention can be combined with the crankshaft 200 of a gasoline engine by the flail block seat 12, letting the flail block 121 positioned in the engage groove 111 of the clutch 10 before the gasoline engine is started. To start the gasoline engine, a user can make use of the motor 30 to drive the starting claw 11 to rotate via the adapter 20. At this time, since the flail block 121 is positioned in the engage groove 111, and the rotating direction of the starting claw 11 is formed in one side of the engage groove 111, where the circumferential wall of the engage groove 111 is perpendicular to the circumferential edge of the starting claw 11, toward another side of the engage groove 111, where the engage recess 111 is gradually deepened; therefore, the starting claw 11 will push the flail block 121 and actuate the flail block seat 12 to turn around and drive the crankshaft 200 to rotate for starting the gasoline engine. Thus, a user can easily start the gasoline engine by making use of the motor 30. After the gasoline engine is started to operate, the crankshaft 200 will drive the flail block seat 12 to rotate and simultaneously, the centrifugal force produced by rotation of the crankshaft 200 will make the free ends 1212 of the flail blocks 121 thrown outward and disengaged from the engage grooves 111 and as a result the starting claw 11, the adapter 20 and the motor 30 will be disconnected from the crankshaft 200. Thus, when the gasoline engine is operated, the gasoline engine is unnecessary to actuate the starting claw 11, the adapter 20 and the motor 30 to work, able to effectively lower load of the engine, reduce power consumption and increase economic benefit. When the gasoline engine is stopped operating, the crankshaft 200 will reduce rotating speed rapidly, and the centrifugal force that the free ends 1212 of the flail blocks 121 bear will decrease. At this time, the action of restoring force of the restoring member 122 will force the free ends 1211 of the flail blocks 121 to be engaged in the engage recesses 111 anew.

The electric starting device 100 of this invention is simple in structure and able to make the flail blocks 121 radially and optionally engaged in or disengaged from the engage recesses 111 by the centrifugal force produced when the electric starting device 100 is rotated. Therefore, the electric starting device 100 can easily be disengaged from the crankshaft 200 by making use of centrifugal force after the gasoline engine is started and also can rapidly be combined with the crankshaft 200 anew after the gasoline engine is stopped operating, able to avoid causing machine trouble or prevent parts from being stuck with greasy dirt and hence able to maintain normal operation of the starting device.

While preferred embodiment of the invention has been described above, it will be recognized and understood that various modifications may be made therein and the appended claims are intended to cover all such modifications that may fall within the spirit and scope of the invention.

What is claimed is:

1. An electric starting device for a gasoline engine comprising:
a clutch, said clutch provided with a starting claw and a flail block seat, said flail block seat provided at one axial side of said starting claw, said starting claw having a circumferential edge radially disposed with at least one engage recess, said flail block seat pivotally assembled with a flail block at a location corresponding to said engage recess, said flail block able to be optionally engaged in said engage recess, said starting claw having one side, opposite to said flail block seat, axially fixed thereon with a plurality of combination ribs;
an adapter, said adapter corresponding with said combination ribs and provided at one side of said clutch, said adapter disposed with a plurality of combination grooves, said combination grooves respectively corresponding with said combination ribs of said starting claw, said adapter and said clutch able to be engaged and combined together, said adapter having one side, opposite to said clutch, formed with a plurality of engage grooves; and
a motor, said motor provided with a rotating shaft, said rotating shaft fixed thereon with a plurality of ribs, said ribs corresponding to said engage grooves of said adapter, said engage grooves and said ribs able to be engaged mutually to enable said rotating shaft to actuate said adapter and said clutch to rotate synchronously.

2. The electric starting device for a gasoline engine as claimed in claim 1, wherein said engage grooves of said adapter axially pierce through said adapter and radially stretching to a circumferential edge of said adapter.

3. The electric starting device for a gasoline engine as claimed in claim 1, wherein said combination grooves axially pierce through said adapter and radially extending to a circumferential edge of said adapter.

4. The electric starting device for a gasoline engine as claimed in claim 1, wherein said combination grooves and said engage grooves are respectively provided in stagger.

5. The electric starting device for a gasoline engine as claimed in claim 1, wherein a circumferential wall of one side of said engage recess is perpendicular to a circumferential edge of said starting claw, and a circumferential wall of another side of said engage recess gradually increases a depth of said engage recess.

6. The electric starting device for a gasoline engine as claimed in claim 5, wherein said flail block has one end pivotally assembled with said flail block seat to form a pivotal end and another end is a free end, said pivotal end of said flail block corresponding to the circumferential wall of one side of said engage recess, when said engage recess is gradually deepened, said free end of said flail block corresponding with a circumferential wall of another side of said engage recess, where said engage recess is perpendicular to the circumferential edge of said starting claw.
